(19) United States
(12) Patent Application Publication
(10) Pub. No.: US 2012/0275176 A1
(43) Pub. Date: Nov. 1, 2012

(54) PROJECTION HEADLIGHTS FOR VEHICLES

(75) Inventor: Gerhard Kloos, Erwitte (DE)

(73) Assignee: HELLA KGAA HUECK & CO., Lippstadt (DE)

(21) Appl. No.: 13/458,143

(22) Filed: Apr. 27, 2012

(30) Foreign Application Priority Data
Apr. 29, 2011 (DE) 102011002336.4

(51) Int. Cl. B60Q 1/04

(52) U.S. Cl. 362/539

(57) ABSTRACT

The invention relates to projection headlights for vehicles with a reflector, with a light source assigned to the reflector, with a lens arranged in the main direction of the beam in front of the reflector and with a screen arranged in the area of the focal point of the lens which comprises an elongated screen edge surface extending diagonally toward the main direction of the beam to depict a light/dark boundary for a predefined light distribution arrangement and that means are provided for softening the light/dark boundary according to a defined softening level, wherein the screen edge surface comprises a softening reflective surface as means for softening the light/dark boundary.

### CROSS-REFERENCE TO RELATED APPLICATIONS

This application claims priority to German Patent application No. DE102011002336.4 filed Apr. 29, 2011.

### BACKGROUND

Projection headlights for vehicles which essentially comprise a reflector, a light source, a lens as well as a screen are disclosed in DE 103 40 433 B4. The screen has an elongated screen edge surface on one top side, which can be used to depict a light/dark boundary of a light distribution arrangement. A reflective surface is arranged in the region of the screen edge surface for the systematic further reflection of part of the light reflected by the reflector toward the lens in order to increase the utilization factor of the light flow. No softening of the light/dark boundary, in the sense that the illuminance gradient of the light distribution arrangement emitted by the light/dark boundary is limited if the vertical angle is reduced, is associated herewith. This kind of softening of the light/dark boundary is always needed to prevent the occurrence of too much contrast which has an unfavorable impact on the driver's perception with respect to the illumination of the traffic area. To soften the light/dark boundary or to reduce the illuminance gradient of the light/dark boundary, it is known to abrade a surface of the lens by means of sandblasting. The disadvantages of said method are that the costs are relatively high and the reproducibility is low.

Therefore, an object of the present invention is to upgrade projection headlights for vehicles in such a way that a simplified softening of the light/dark boundary of the light distribution arrangement is ensured.

### SUMMARY OF THE INVENTION

To solve this object, the invention is characterized in that the screen edge surface has a softening reflective surface as means for softening the light/dark boundary. The invention relates to projection headlights for vehicles with a reflector, with a light source assigned to the reflector, with a lens arranged in the main direction of the beam in front of the reflector and with a screen arranged in the area of the focal point of the lens which comprises an elongated screen edge surface extending diagonally to the main direction of the beam to depict a light/dark boundary for a predefined light distribution arrangement and that means are provided for softening the light/dark boundary HDG according to a defined softening level, characterized in that the screen edge surface comprises a softening reflective surface as means for softening the light/dark boundary.

According to the invention, it is intended that means for softening the light/dark boundary HDG according to a predefined softening level are arranged on the screen, specifically on an elongated screen edge surface of the screen. Said elongated screen edge surface is equipped with a softening reflective surface to achieve the predefined softening level of the light/dark boundary. The basic idea of the invention is to provide the softening means on such a location or component which is responsible for the development of the light/dark boundary. Advantageously only a relatively small surface area needs to be treated to achieve the desired softening. It is easier to check the quality of the reflective optical surface than a sandblasted surface with measuring equipment. The invention facilitates better reproducibility. The invention enables a controlled intervention involving the projection headlights, which can also be performed retroactively. Furthermore, the invention enables an increase of the illuminance maximum near the light/dark boundary.

According to a preferred embodiment of the invention, the softening reflective surface is equipped with a reflective level ranging between 20% and 40%, preferably 30% on the screen edge surface, so that the illuminance gradient of the light distribution arrangement has a desirable progress on the light/dark boundary. Changing the reflective level allows the relatively accurate and predictable setting of a desired illuminance gradient or gradient progress.

In an upgrade of the invention, in particular a flattened terminal output piece of a vertical illuminance gradient can be provided in simple fashion directly up to the point of the light/dark boundary in order to achieve the desired softening level.

According to an upgrade of the invention, the terminal output piece of the illuminance gradient decreases toward the direction of the light/dark boundary as far as an illuminance value of 1 1× is not exceeded in a horizontal angle of 0° and in a vertical angle of 0° of the light distribution arrangement. Hence, the invention allows a soft tapering off of the illuminance gradient in the direction of the light/dark boundary, whereby other light-related requirements are met.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Exemplary embodiments of the invention are explained in more detail below by means of drawings.

In the figures:

FIG. 1 shows a perspective representation of projection headlights in a top side view, wherein only an upper area of a screen is illustrated for the sake of simplicity,

FIG. 2 shows a schematic low beam arrangement without the use of softening agents for the light/dark boundary,

FIG. 3 shows a schematic low beam arrangement with the use of softening means according to the invention, and

FIG. 4 shows a diagram of a vertical illuminance gradient in the area of the light/dark boundary.

### DETAILED DESCRIPTION

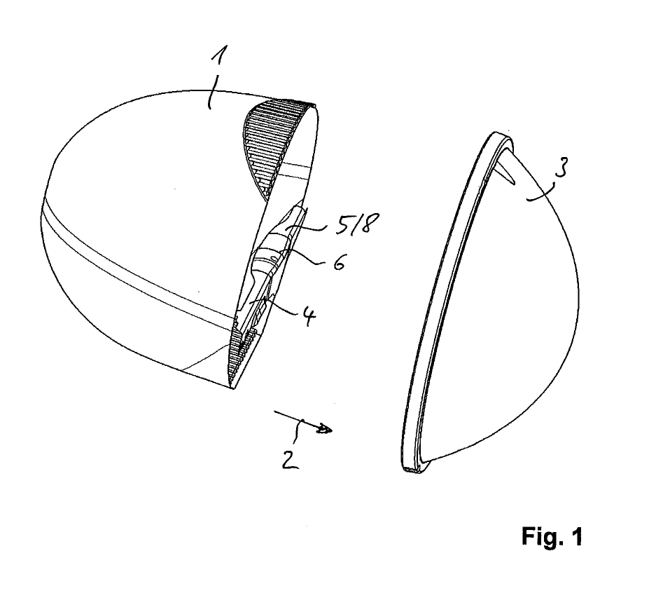

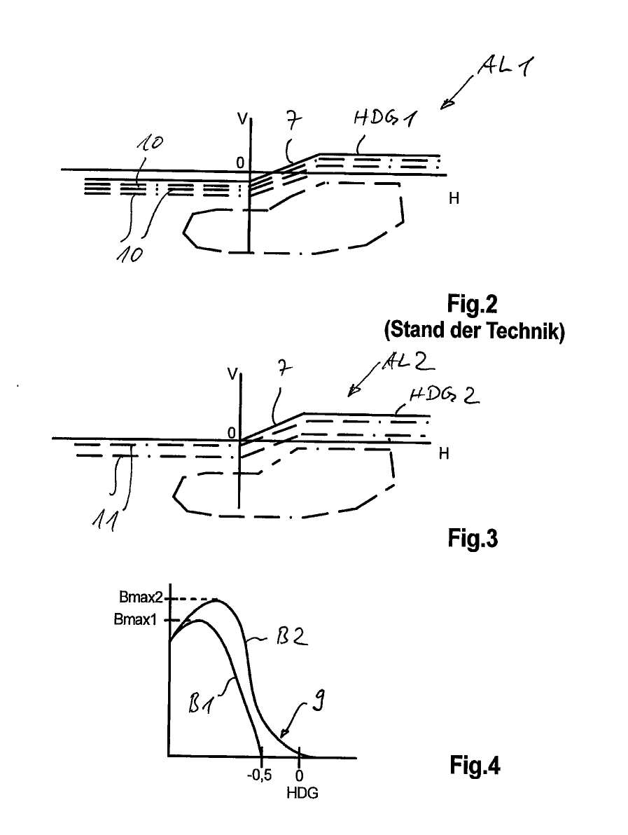

Projection headlights for vehicles essentially comprise a reflector 1, a not illustrated light source assigned to the reflector 1, a lens 3 arranged in the main direction of the beam 2 in front of the reflector 1 as well as a screen 4, arranged in the area of a focal point of the lens 3 between the light source and the lens 3. For the sake of simplicity, FIG. 1 only illustrates an upper area of the screen 4, which comprises an elongated screen edge surface 5 on its top side to generate a low beam arrangement. The screen edge surface 5 normally comprises a 15° section 6, by means of which sloping areas 7 of low beam arrangements AL1, AL2 illustrated in FIGS. 2 and 3 are depicted according to the ECE standard.

The screen 4 or the screen edge surface 5, respectively, is normally made of a sheet steel material without reflective properties. FIG. 2 illustrates the low beam arrangement AL1 of the projection headlights for which the screen 4 was not subject to a special treatment and the lens 3 was not subject to sandblasting. As can be seen, the isolux lines 10 of the low beam arrangement AL1 are arranged relatively close to each other in the direct vicinity of a light/dark boundary HDG1. An illuminance gradient B1 with a horizontal angle of −1° of the low beam arrangement AL1 illustrated in FIG. 4 has a relatively large absolute illuminance gradient, which becomes 0 in the area of a horizontal angle of −0.5°. Hence, the illuminance gradient B1 in the direction of the light/dark boundary HDG1 is relatively steep, and the goal is to flatten it in an area close to the light/dark boundary HDG1 by way of treating the screen 4 according to the invention.

For this purpose, the invention comprises a softening reflective surface 8 as means for softening the light/dark boundary HDG on the screen edge surface 5, which comprises a reflective level in the range of 20%-40%, preferably a reflective level of 30%. The softening reflective surface 8 is applied all over a reflective coating onto the screen edge surface 5 and covers the entire top side of the screen edge surface 5. The reflective level allows the setting of a softening level which ensures that the isolux lines 11 of a low beam arrangement AL2 according to the invention arranged close to a light/dark boundary HDG2 according to FIG. 3 are spaced further apart from each other than corresponding isolux lines 10 according to FIG. 2. With a horizontal angle of −1° of the low beam arrangement AL2, the resulting illuminance gradient B2 in the direct vicinity of the light/dark boundary HDG2 has a relatively lower absolute illuminance gradient in a terminal output piece 9 of the illuminance gradient B2. The terminal output piece 9 borders directly onto the light/dark boundary HDG2 and extends within an area between the horizontal angle of −0.5° and 0°. The flattened gradient of the illuminance gradient curve B2 in the region of the terminal output piece 9 allows the softening of the light/dark boundary HDG2 in the desired fashion. The terminal output piece 9 runs asymptotically to the horizontal line H, whereby an illuminance value of 1 1× is not exceeded on the horizontal angle 0° and the vertical angle 0° of the low beam arrangement AL2.

Furthermore, the invention makes it possible that a maximum value BMax 2 in the region of the light/dark boundary HDG is greater than an illuminance maximum BMax 1 of the low beam arrangement ALL Hence, the invention enables a soft tapering off toward the light/dark boundary HDG2 in the region of the light/dark boundary, wherein an increased illuminance maximum BMax 2 can be achieved in a vertical angular distance of more than 0.5° to the light/dark boundary HDG2.

According to a further embodiment of the invention which is not illustrated, the screen edge surface 5 can also be equipped only partly with the softening reflective surface 8. Alternatively, it also possible to apply softening reflective surface sections onto the screen edge surface 5 which have a different reflective level.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1-10. (canceled)

11. A projection headlight screen for vehicles with a reflector, with a light source assigned to the reflector, with a lens arranged in the main direction of the beam in front of the reflector comprising:
a screen arranged in an area of a focal point of the lens which comprises an elongated screen edge surface extending diagonally toward the main direction of the beam to form a light/dark boundary for a predefined light distribution arrangement;
a softening reflective surface disposed on said screen edge surface to soften the light/dark boundary according to a defined softening level.

12. The projection headlight screen according to claim 1, characterized in that the softening reflective surface has a reflective level ranging between about 20% and about 40%.

13. The projection headlights according to claim 1, characterized in that the softening reflective surface has a reflective level of about 30%.

14. The projection headlights according to claim 1, characterized in that the softening reflective surface is formed with a reflective coating.

15. The projection headlights according to claim 1, characterized in that the softening reflective surface extends across the entire top side of the screen edge surface.

16. The projection headlight screen according to claim 1, characterized in that the softening reflective surface forms a light distribution arrangement in the region of the light/dark boundary has a vertical illuminance gradient, for which a flattened terminal output piece borders directly onto the light/dark boundary.

17. The projection headlights according to claim 6, characterized in that the terminal output piece of the vertical illuminance gradient asymptotically tends to 0.

18. The projection headlights according to claim 6, characterized in that the terminal output piece of the vertical illuminance gradient proceeds in such a way that is does not exceed an illuminance value of about 1 1× in a horizontal angle of about 0° and in a vertical angle of about 0° of the light distribution arrangement.

19. The projection headlights according to claim 1, characterized in that the screen edge surface forms a low beam arrangement with about a 15° sloping area.

20. The projection headlights according to claim 1, characterized in that the screen is made of a sheet steel material and that the softening reflective surface is applied to the screen edge surface by way of coating.
